(19) United States
(12) Patent Application Publication
(10) Pub. No.: US 2004/0242832 A1
(43) Pub. Date: Dec. 2, 2004

(54) Autocatalytic polyols with gelling characteristics and polyurethane products made therefrom

(76) Inventors: Francois M Casati, Pfaffikon (CH); Raymond J Swedo, Mt Prospect, IL (US); Ronald M Herrington, Brazoria, TX (US); Jean-Marie L Sonney, Gingins (CH); Christopher P Christenson, Lake Jackson, TX (US); Alan K Schrock, Lake Jackson, TX (US); Nelson G Rondan, Missouri City, TX (US); Mark F Sonneschein, Midland, MI (US); Debkumar Bhattacharjee, Lake Jackson, TX (US); Ray E Drumright, Midland, MI (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/489,745

(22) PCT Filed: Oct. 1, 2002
(86) PCT No.: PCT/US02/31274

Related U.S. Application Data
(60) Provisional application No. 60/326,238, filed on Oct. 1, 2001.

(51) Int. Cl. C08G 18/00

(52) U.S. Cl. 528/44

(57) ABSTRACT

The present invention discloses a process for producing a polyurethane product with autocatalytic polyols with gelling characteristics. These auto-catalytic polyols are reacted with a polyisocyanate in the presence of other additives and/or auxiliary agents known per se to produce polyurethane products.

The present invention pertains to polyurethane polymer products made from autocatalytic polyols with gelling characteristics and to the process for their manufacture.

Polyether polyols based on the polymerization of alkylene oxides, and/or polyester polyols, together with isocyanates are the major components of a polyurethane system. The rate of reaction between polyols and isocyanates and level of completion of these reactions over time are a measure of the gelation profile of polyurethane systems. In case of foams a blowing agent is usually added and in most cases it is water. The reaction between isocyanate and water is referred to as the blowing reaction. Additionally these systems generally contain other components such as cross-linkers, chain extenders, surfactants, cell regulators, stabilizers, antioxidants, flame retardant additives, eventually fillers, and typicallycatalysts such as tertiary amines and/or organometallic salts. The degree of gelation and eventually of blowing rates of polyurethane systems are highly dependent on the type and level of catalysts used in the process.

Organometallic catalysts, such as lead or mercury salts, can raise environmental issues due to leaching upon aging of the polyurethane products. Others, such as tin salts, are often detrimental to polyurethane aging.

The commonly used tertiary amine catalysts give rise to several problems, particularly in flexible, semi-rigid and rigid foam applications. Freshly prepared foams using these catalysts often exhibit the typical odor of the amines and give rise to increased fogging (emission of volatile products).

The presence, or formation, of even traces of tertiary amine catalyst vapors in polyurethane products having vinyl films or polycarbonate sheets exposed thereto can be disadvantageous. Such products commonly appear in automotive interiors as seats, armrests, dashboards or instrument panels, sun visors, door linings, noise insulation parts either under the carpet or in other parts of the car interior or in the engine compartment, as well as in many domestic applications such as shoe soles, cloth interliners, appliance, furniture and bedding. While these materials perform excellently in these applications, they possess a deficiency that has been widely recognized. Specifically, the tertiary amine catalysts present in polyurethane foams have been linked to the staining of the vinyl film or leather and degradation of polycarbonate sheets. These PVC staining and polycarbonate decomposition problems are especially prevalent in environments wherein elevated temperatures exist for long periods of time, such as in automobile interiors, which favor emission of amine vapors.

Various solutions to this emission problem have been proposed. For instance, U.S. Pat. No. 4,517,313 discloses the use of the reaction product of dimethylaminopropylamine and carbonic acid as a catalyst for use in the manufacture of polyurethane. The use of this catalyst is stated to reduce odor and vinyl staining relative to the use of triethylenediamine catalyst. Triethylenediamine is considered the standard gelling catalyst for urethane reactions as confirmed by suppliers' literature such as Air Products, Urethane Additives bulletin 120-747 on Dabco* crystal (Trademark of APCI), while bis(2-dimethylaminoethyl) ether is regarded as the standard blowing catalyst, as confirmed by product literature on Niax™ A-99 (trademark of Crompton Corporation). The amine catalyst disclosed in U.S. Pat. No. 4,517,313 cannot match the performance of triethylenediamine in polyurethane curing since it is a much weaker catalyst. EP 176,013 discloses the use of specific aminoalkylurea catalysts in the manufacture of polyurethanes. Use of these catalysts is also said to reduce odor and vinyl staining through the use of relatively high molecular weight amine catalysts. Due to their high molecular weight, these amine catalysts are unable to readily migrate through a polyurethane foam and thus their propensity to produce odors and stain vinyl films is reduced. However, when subjected to elevated temperatures as are commonly encountered in automobile interiors, these compounds migrate within a foam to some degree. Again, these products cannot compare in gelling performance with triethylenediamine.

Use of amine catalysts which contain a hydrogen isocyanate reactive group such as a hydroxyl or a primary and/or a secondary amine are proposed by catalyst suppliers. One such compound is disclosed in EP 747,407. Other types of reactive catalyst are described in U.S. Pat. No. 4,122,038 and in EP 677,540. Reactive amine catalysts with gelation characteristics are claimed in U.S. Pat. No. 3,448,065; in U.S. Pat. No. 5,143,944; in U.S. Pat. No. 5,710,191 and in U.S. Pat. No. 5,233,039. A reported advantage of the catalyst composition is that they are incorporated into the polyurethane product. However those catalysts have to be used at higher levels in the polyurethane formulation than conventional fugitive tertiary amines to compensate for their lack of mobility during the reactions and to get normal processing conditions. In addition, once they are reacting with isocyanate during the polyurethane manufacturing process they lose activity and cannot catalyze strongly enough the back-end of the urethane reactions which is most important for the gelation of the polyurethane systems.

Pre-polymerization of reactive amine catalysts with a polyisocyanate and a polyol is reported in PCT WO 94/02525. These isocyanate-modified amines show comparable or enhanced catalytic activity compared with the corresponding non-modified amine catalysts. However, these amine based prepolymers give handling difficulties such as gel formation and poor storage stability.

Specific crosslinkers are proposed in U.S. Pat. No. 4,963,399 to produce polyurethane foams that exhibit a reduced tendency to stain vinyl films. These crosslinkers cannot be used at levels sufficient to get the desired catalytic activity, since they negatively affect foam processing and foam properties due to their crosslinking effect. Such disadvantages would also be present for long chain tertiary aminoalcohol crosslinkers as disclosed in EP 488,219.

Modification of polyols by partial amination has been disclosed in U.S. Pat. No. 3,838,076. While this gives additional reactivity to the polyol, this does not allow adjustment of processing conditions since these aminated functions are rapidly tied in the polymer by reacting with the isocyanate. Hence they give fast initiation of the reactions but subsequently lose most of their catalytic activity.

Process for the production of tertiary amines exhibiting carbonate and urethane groups, and optionally hydroxyl groups, is described in EP 696,580.

Use of specific amine-initiated polyols is proposed in EP 539,819 and in U.S. Pat. No. 5,476,969 whereby a “spacer bridge” technology is developed to give more catalytic activity to the amine starter of the claimed polyols. However, no mention of the gelation activity of these polyols is reported. A polyamine-initiated polyol technology is described in U.S. Pat. No. 5,672,636 and is applied to semi-rigid and rigid polyurethane foam productions which are based on high functionality isocyanate. Gelation is mainly provided by the isocyanate.

Amine based polyols are described in WO 01/58,976 and mention is made of polyols with blowing and gelling characteristics. However these are obtained by playing with functionalities, equivalent weights and the ratio between EO (ethylene oxide) and PO (propylene oxide). It is well known that increasing the level of primary hydroxyls of a polyol by adding more EO capping gives improved gelation, but this does not allow a significant reduction in amine and/or organo-metallic catalysis.

Acid modified polyoxypropyleneamine are used as catalysts in U.S. Pat. No. 5,308,882 but still require the use of an organometallic co-catalyst.

Therefore, there continues to be a need to control vinyl or leather staining and polycarbonate decomposition by polyurethane compositions and to improve polyurethane aging via elimination or reduction of the amount of amine catalysts and/or organometallic salts through the use of autocatalytic polyols with gelling characteristics in producing polyurethane products.

There is also a need to get autocatalytic polyols with gelling characteristics for efficient urethane processes.

There is also a need for autocatalytic polyols with gelling characteristics to be combined at selected ratios with autocatalytic polyols having blowing characteristics, when making poyurethane foams.

It is an object of the present invention to produce polyurethane products containing a reduced level of gelling tertiary amine catalysts, or polyurethane products produced in the absence of such amine catalysts. It an another objective of the present invention to produce polyurethane products containing a reduced level of organometallic catalyst or to produce such products in the absence of organometallic catalysts. With the reduction of the amount of gelling amine and/or organometallic catalysts needed or elimination of such catalysts, the disadvantages associated with such catalysts as given above can be minimized or avoided.

It is a further object of the present invention to provide polyols containing autocatalytic activity with gelation characteristics so that the industrial manufacturing process of the polyurethane product is not adversely affected and may even be improved by the reduction in the amount of gelling amine catalysts or by elimination of the amine catalyst, and/or by reduction or elimination of organometallic catalysts.

It is a further object of the present invention to provide, in case of foams, autocatalytic polyols with gelation characteristics which can be used in conjunction with autocatalytic polyols having blowing characteristics at various ratios in order to adjust reaction profiles with or without addition of reduced amounts of amine and/or organometallic catalysts.

In another aspect, the use of the autocatalytic polyols of the present invention could reduce the level of amine catalysts to which workers would be exposed in the atmosphere in a manufacturing plant.

The present invention is a process for the production of a polyurethane product by reaction of a mixture of

(a) at least one organic polyisocyanate with

(b) a polyol composition comprising

(b1) from 0 to 99 percent by weight of a polyol compound having a functionality of 2 to 8 and a hydroxyl number of from 20 to 800 and

(b2) from 100 to 1 percent by weight of at least one autocatalytic polyol with gelling characteristics, having a functionality of 1 to 8 and a hydroxyl number of from 15 to 800,

wherein the weight percent is based on the total amount of polyol component (b), and (b2) is obtained by alkoxylation of at least one initiator molecule of (b2a), (b2b), (b2c), (b2d), (b2e), (b2f) or (b2g) wherein

(b2a) is a compound of Formula I

R₂N—(CH₂)ₙ—NH—(CH2)ₙ—NR₂ (Formula I)

where n at each occurrence is independently an integer from 1 to 12,

and R at each occurrence is independently a C₁ to C₃ alkyl group;

(b2b) is a compound of Formula II

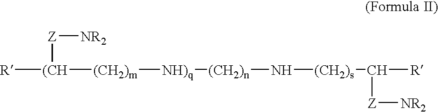

where R and n are as previously defined,

R′ at each occurrence is independently hydrogen, a linear or branched C₁ to C₁₂ alkyl, OH or NH₂,

m at each occurrence is independently an integer from 0 to 12,

q and s are independently integers from 0 to 12,

with the proviso that s is less than 3 when q is 0 and R′ is NH₂; and

Z at each occurrence is independently a direct bond or a linear or branched C₁ to C₁₂ alkyl;

(2bc) is a compound of Formula III

ₚ(E)-A[(CE₂)ₙ—N(E)—(CE₂)ₙ]ⱼ-A-(E)ₚ (Formula III)

where E at each occurrence is independently hydrogen, C₁—C₁₂ linear or branched alkyl, —RNR₂ or —ROH;

where n at each occurrence is independently an integer from 1 to 12;

R at each occurrence is independently a C₁ to C₃ alkyl group;

j is 1 to 6;

A is oxygen or nitrogen, and

p is 1 when A is oxygen and 2 when A is nitrogen,

with the provisos that n is at least 3 when each A is nitrogen and the molecule contains at least one NR₂ group;

(b2d) is a compound of Formula IV

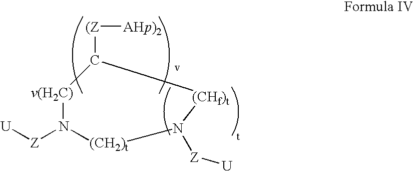

where Z, A, and p, are as previously defined,

v at each occurrence is independently an integer from 0 to 6,

t is an integer from 2 to 6, f is 1 or 2, and

U at each occurrence is independently a C₁ to C₃ linear or branched alkyl, hydrogen, or NR₂ where R is as previously defined;

(b2e) is a compound W being selected from a cyclic or an aliphatic molecule containing an amidine group, a quinuclidine group, a triazaadamantane group, a N-methyl-piperazine group, an imidazole group, a pyridine group or a pyrrolidino group with one or more reactive hydrogens and eventually being sustituted with one or more methyl group,

(b2f) is a compound which contains W with or without reactive hydrogens, as represented by in Formula V

W-((CH₂)ₘ-AHₚ)ᵥ (Formula V)

where W, A, m, v and p are previously defined, group with the proviso that when W is an imidazole group the hydroxyl number of (b2) is 48 or less and when W is a quinuclidine the hydroxyl number of (b2) is 200 or less;

(b2g) is a compound with contains a W groups as represented by Formula VI

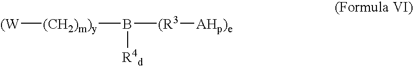

where W, A, m and p are as previously defined,

B is carbon, oxygen or nitrogen,

R⁴ is hydrogen or a C₁ to C₁₂ linear or branched alkyl,

R³ is C₁ to C₁₂ linear or branched alkyl,

e and y are 1 and d is zero when B is oxygen,

e and y are 1 and d is 2 when B is carbon,

when B is nitrogen, e, y and d are 1 or y is 2, d is zero and e is 1;

or (b2) is either (b2e), (b2f), or (b2g) complexed with a metal salt;

or (b2) is (b2h) a hydroxyl-tipped prepolymer obtained from the reaction of an excess of (b2a), (b2b), (b2c), (b2d), (b2e) (b2f), or (b2g) with a polyisocyanate;

or (b2) is (b2i) a blend selected from (b2a), (b2b) (b2c), (b2d), (b2e), (b2f), (b2g), or (b2h);

(c) optionally in the presence of a blowing agent; and

(d) optionally additives or auxiliary agents known per se for the production of polyurethane foams, elastomers and/or coatings.

In another embodiment the above polyol formulation contains an autocatalytic polyol (b3) wherein the autocatalytic polyol contains at least one N-methy amino group in the initiator molecule or in the polyol chain, and preferably contains no dimethylamino groups.

In another embodiment, the present invention is a process as disclosed above wherein (b1) and/or (b2) and/or (b3) are copolymer polyols with at least 1 percent and up to 60 percent SAN, PIPA or PHD solids and preferably 10 to 20 percent solids.

In another embodiment, the present invention is a process as disclosed above wherein the polyisocyanate (a) contains at least one polyisocyanate that is a reaction product of a excess of polyisocyanate with a polyol as defined by (b2a) to (b2g) above, or a mixture thereof.

In a further embodiment, the present invention is a process as disclosed above where the polyisocyanate contains a polyol-terminated prepolymer obtained by the reaction of an excess of polyol with a polyisocyanate wherein the polyol is a polyol as defined by (b2a) to (b2g) above, or a mixture thereof.

The invention further provides for polyurethane products produced by any of the above processes.

In still another embodiment, the present invention is an isocyanate-terminated prepolymer based on the reaction of a polyol as defined by (b2a) to (b2g) or a mixture thereof with an excess of a polyisocyanate.

In yet another embodiment, the present invention is a polyol-terminated prepolymer based on the reaction of a polyisocyanate with an excess of polyol as defined by (b2a) to (b2g) or a mixture thereof.

The polyols containing bonded tertiary amine groups as disclosed in the present invention are catalytically active and accelerate the addition reaction of organic polyisocyanates with polyhydroxyl or polyamino compounds and the reaction between the isocyanate and the blowing agent such as water or a carboxylic acid or its salts. They are especially effective to catalyze the gelation reaction. The addition of these polyols to a polyurethane reaction mixture reduces or eliminates the need to include a gelling tertiary amine catalyst within the mixture or an organometallic catalyst.

In accordance with the present invention, a process for the production of polyurethane products is provided, whereby polyurethane products of relatively low odor and low emission of amine catalyst are produced. Furthermore, the polyurethane products produced in accordance with the invention exhibit a reduced tendency to stain vinyl films and leather or to degrade polycarbonate sheets with which they are exposed, display excellent adhesion properties (in appropriate formulations), have a reduced tendency to produce ‘blue haze’ which is associated with the use of certain tertiary amine catalysts, and are more environmental friendly through the reduction/elimination of organometallic catalysts. These advantages are achieved by including in the reaction mixture either a polyol (b2) at selected concentrations or by including polyol (b2) as feedstock in the preparation of a SAN (styrene-acrylonitrile), PIPA (poly isocyanate poly addition)or PHD (polyharnstoff dispersion) copolymer polyol or by adding (b2) to conventional copolymer polyols or by using (b2) in a prepolymer with a polyisocyanate alone or with an isocyanate and a second polyol which can be optionally (b1) and/or (b3).

The combination of polyols used in the present invention will be a combination of (b1) and (b2) as described above and optionally with polyol eventually (b3). As used herein the term polyols are those filled and unfilled materials having at least one group containing an active hydrogen atom capable of undergoing reaction with an isocyanate. Preferred among such compounds are materials having at least two hydroxyls, primary or secondary, or at least two amines, primary or secondary, carboxylic acid, or thiol groups per molecule. Compounds having at least two hydroxyl groups per molecule are especially preferred due to their desirable reactivity with polyisocyanates.

Suitable polyols (b1) that can be used to produce polyurethane materials with the autocatalytic polyols (b2) of the present invention are well known in the art and include those described herein and any other commercially available polyol and/or SAN, PIPA or PHD copolymer polyols. Such polyols are described in Polyurethane handbook, by G. Oertel, Hanser publishers. Mixtures of one or more polyols and/or one or more copolymer polyols may also be used to produce polyurethane foams according to the present invention.

Representative polyols include polyether polyols, polyester polyols, polyhydroxy-terminated acetal resins, hydroxyl-terminated amines and polyamines. Examples of these and other suitable isocyanate-reactive materials are described more fully in U.S. Pat. No. 4,394,491, the disclosure of which is incorporated herein by reference. Alternative polyols that may be used include polyalkylene carbonate-based polyols and polyphosphate-based polyols. Preferred are polyols prepared by adding an alkylene oxide, such as ethylene oxide (EO), propylene oxide (PO), butylene oxide (BO) or a combination thereof, to an initiator having from 2 to 8, preferably 2 to 6 active hydrogen atoms. Catalysis for this polymerization can be either anionic or cationic, with catalysts such as KOH, CsOH, boron trifluoride, or a double cyanide complex (DMC) catalyst such as zinc hexacyanocobaltate or phosphazenium.

The polyol or blends thereof employed depends upon the end use of the polyurethane product to be produced. The molecular weight or hydroxyl number of the base polyol may thus be selected so as to result in flexible, semi-flexible, integral-skin or rigid foams, elastomers or coatings, or adhesives when the polymer/polyol produced from the base polyol is converted to a polyurethane product by reaction with an isocyanate, and depending on the end product in the presence of a blowing agent. The hydroxyl number and molecular weight of the polyol or polyols employed can vary accordingly over a wide range. In general, the hydroxyl number of the polyols employed may range from 20 to 800.

In the production of a flexible polyurethane foam, the polyol is preferably a polyether polyol and/or a polyester polyol. The polyol generally has an average functionality ranging from 2 to 5, preferably 2 to 4, and an average hydroxyl number ranging from 20 to 100 mg KOH/g, preferably from 20 to 70 mgKOH/g. As a further refinement, the specific foam application will likewise influence the choice of base polyol. As an example, for molded foam, the hydroxyl number of the base polyol may be on the order of 20 to 60 with EO capping, and for slabstock foams the hydroxyl number may be on the order of 25 to 75 and is either mixed feed EO/PO or is only slightly capped with EO. For elastomer applications, it will generally be desirable to utilize relatively high molecular weight base polyols, from 2,000 to 8,000, having relatively low hydroxyl numbers, for example, 20 to 50.

Typically polyols suitable for preparing rigid polyurethanes include those having an average molecular weight of 100 to 10,000 and preferably 200 to 7,000. Such polyols also advantageously have a functionality of at least 2, preferably 3, and up to 8, preferably up to 6, active hydrogen atoms per molecule. The polyols used for rigid foams generally have a hydroxyl number of 200 to 1,200 and more preferably from 300 to 800.

For the production of semi-rigid foams, it is preferred to use a trifunctional polyol with a hydroxyl number of 30 to 80.

The initiators for the production of polyols (b1) generally have 2 to 8 functional groups that will react with the polyol. Examples of suitable initiator molecules are water, organic dicarboxylic acids, such as succinic acid, adipic acid, phthalic acid and terephthalic acid and polyhydric, in particular dihydric to octahydric alcohols or dialkylene glycols, for example ethanediol, 1,2- and 1,3-propanediol, diethylene glycol, dipropylene glycol, 1,4-butanediol, 1,6-hexanediol, glycerol, trimethylolpropane, pentaerythritol, sorbitol and sucrose or blends thereof. Other initiators include compounds linear and cyclic compounds containing a tertiary amine such as ethanoldiamine, triethanoldiamine, and various isomers of toluene diamine.

The autocatalytic polyols having gelling catalytic activity (b2) are those described by (b2a), (b2b), (b2c), (b2d), (b2e), (b2f), (b2g), or (b2h). Polyol (b2) with gelling characteristics is defined as an autocatalytic polyol which can be substituted for at least 10 percent and up to 100 percent of a gelling amine catalyst, such as triethylenediamine, with the formulation keeping the same reactivity profile.

The properties of the autocatalytic polyols can vary widely as described above for polyol (b1) and such parameters as average molecular weight, hydroxyl number, functionality, etc. will generally be selected based on the end use application of the formulation, that is, what type of polyurethane product. The selection of a polyol with the appropriate hydroxyl number, level of EO, PO and/or BO, functionality and equivalent weight for a particular application is known to those skilled in the art. For example, polyols with a high level of EO will be hydrophilic, while polyols with a high amount of PO or BO will be more hydrophobic.

The production of polyols containing the initiators (b2a), (b2b), (b2c), (b2d), (b2e), (b2f), or (b2g) can be done by procedures well known in the art as disclosed for (b1). The addition of the first alkylene oxide moles onto the products of formula (b2a) to (b2g) can be done auto-catalytically, that is, without addition of catalyst. In general, a polyol (b2) is made by the addition of an alkylene oxide (EO, PO, or BO), or a combination of alkylene oxides to the initiator by anionic or cationic reaction, KOH or CsOH or use of DMC catalyst or BF3 or phosphazenium catalyst as described in EP 897,940. For some applications only one alkylene oxide monomer is used, for other applications a blend of monomers is used and in some cases a sequential addition of monomers is preferred, such as PO followed by an EO feed, EO followed by PO, etc.

Processing conditions such as reactor temperature and pressure, feeding rates and catalyst level are adjusted to optimize production yield and minimize color. Generally conditions are selected to produce a polyol with an unsaturation below 1 meq/g.

Optionally polyol (b2) is used as total or partial feedstock to manufacture copolymer polyols.

The use of polyols (b2) include conditions where the polyol is reacted with a polyisocyanate to form a prepolymer and subsequently polyol is optionally added to such a prepolymer. Thus polyols having functionality greater than what is given based on initiators (2ba)-(2bh) can be obtained. For example, a diisocyanate such as 4,4′-diphenylmethane diisocyanate, can be reacted with an excess of initiator to couple it and the initiator-terminated polyisocyanate prepolymer can subsequently be reacted with an alkylene oxide. Higher functional compounds can also be prepared by coupling the initiators by reaction with a diepoxide compound such as ERL 4221 made by Union Carbide Corporation. Use of glycidol also gives poyols with increased functionalities.

Another way to increase polyol (b2) starter functionality is to use compounds containing tertiary amine and ketone, condense with malonate type compounds and then reduce or transeterify to yield proper initiator. For instance quinuclidinone, 1-methyl-piperidinone, tropinone or (dimethylamino)-acetone can be used with cyanoacetate, malonitrile or malonate esters to prepare initiators with different functionalities, giving with malonate esters a functionality of 2, with cyanoacetate a functionality of 3 and with malonitrile a functionality of 4. Higher functionalities can be obtained through transesterification/amidation.

Similarly, aminoalcohols which could be used as polyol initiators can be produced from cyanohydrins prepared from molecules bearing tertiary amines and ketones or aldehydes.

Polyester polyols can be prepared by the reaction of (b2) with a diacid. These can be used in combination with conventional polyester polyols as used today in slabstock or in elastomers, such as shoe soles, or can be used in combination with polyether polyols (b1) and/or (b3).

Polyol (b3) having blowing characteristics are described for instance in WO 01/58,976. More specifically polyol (b3) are those with blowing characteristics is defined as an autocatalytic polyol which can be substituted for at least 10 percent and up to 100 percent of a blowing amine catalyst such as bis(2-dimethylaminoethyl)-ether while maintaining the same reaction profile.

The limitations described with respect to the characteristics of the polyols (b1), (b2) and (b3) above are not intended to be restrictive but are merely illustrative of the large number of possible combinations for the polyol or polyols used.

The initiators (b2a) to (b2g) are commercially available or can be prepared by procedures known in the art.

In one embodiment of Formula I, R is methyl. Preferably n in Formula I is an integer of 2 to 4. In a preferred embodiment, R is methyl and n is an integer of 2 to 4. An example of commercially available compounds of Formula I is bis-(N,N-dimethyl-3-amino propyl)-amine.

Similarly for compounds of Formula II, R is preferably methyl and R′ at each occurrence is hydrogen an alkyl with the same number of carbon atoms. When R′ is an alkyl, preferably it is methyl. Z is preferably a direct bond or a C₁ alkyl. M, and s are preferably integers from 2 to 6. Preferably q is from 0 to 6. A representative example of Formula II is N,N-dimethyl-N′-ethylethylenediamine.

For compounds of Formula III, in a preferred embodiment A at each occurrence is nitrogen. In another embodiment, at least one of A is oxygen. When A at each occurrence is nitrogen, then n at each occurrence is at least 3. Preferably j is 1 to 3. For appropriate catalytic activity, initiators of Formula III contain at least one —NR₂ group, preferably where R is hydrogen. A representative example of Formula III is N,N,2,2-tetramethyl-1,3-propanediamine.

For compounds of Formula IV, f for each group of (CH_{f}) is independently 1 or 2 which can provide for a ring structure with double bonds. For this double bond, it is apparent f must be 1 for two adjacent groups, that is —CH═CH. Representative examples of Formula IV are Cyclen, and 5-amino-1,3-diisopropyl-5-hydroxymethylhexahydropyrimidine.

Examples of compounds of (b2e) containing an amidine are disclosed in U.S. Pat. No. 4,006,124, the disclosure of which is incorporated herein by reference. Examples of W compounds in (b2e) include imidazole, 2,2-bis-(4,5-dimethylimidazole), 2-ethyl 4-methyl imidazole, 2-phenyl imidazole, 1,5,7-triazabicyclo (4,4.0) dec-5-ene, dicyandiamide, 1,1,3,3-tetramethyl guanidine, 2-amino-pyrimidine and 3-pyrrolidinol.

For compounds of Formula V, the value for v will depend on the number of available bonds on the core molecule W. Preferably v is 1 or 2. Representative examples of Formula V are 1-amino-4-methyl-piperazine; 2,4-diamino-6-hydroxypyrimidine; 2-aminopyrimidine; 1-(3-aminopropyl)-imidazole; 3-quinuclidinol; 3-hydroxymethyl quinuclidine; 7-amino-1,3,5-triazaadamantane.

Preferably R³ and R⁴ in Formula VI are C₁ to C₈ linear or branched alkyl. Representative examples of Formula VI include is 1-methy-4-[N-methyl-N-(2-amino-2-methylpropyl)amino]piperidine, and 7-(N-(2-nitroisobutylamino))-1,3,5-triazaadamantane.

The polyols (b2f), (b2g), (b2h) or (b2i) can be complexed with a metal salt. A metal salt can be represented by the generally formula MeXfYg where

Me represents an (f+g) valent metal

X represents an aliphatic hydrocarbon radical with 1 to 18 carbon atoms, an aromatic hydrocarbon radical with 6 to 10 carbon atoms, or an araliphatic hydrocarbon radical with 7 to 15 carbon atoms,

Y represents an aliphatic C2-C18 carboxylate anion with a single negative charge and optionally containing olefinic double bonds and/or alcoholic hydroxyl groups, or a C3-C18 enolate anion carrying a single negative charge

f=0 to 2

g=0 to 4 with the proviso that n+m together=2 to 4.

The weight ratio of (b1) to (b2) will vary depending on the amount of additional catalyst and/or on the amount of autocatalytic polyol (b3) one may desire to add to the reaction mix and to the reaction profile required by the specific application. Generally if a reaction mixture with a base level of catalyst having specified curing time, (b2) is added in an amount so that the curing time is equivalent where the reaction mix contains at least 10 percent by weight less catalyst. Preferably the addition of (b2) is added to give a reaction mixture containing 20 percent less catalyst than the base level. More preferably the addition of (b2) will reduce the amount of catalyst required by 30 percent over the base level. For some applications, the most preferred level of (b2) addition is where the need for a volatile tertiary or reactive amine catalysts or organometallic salt is totally eliminated.

Combination of two or more gelling autocatalytic polyols of (b2) type and/or blowing autocatalytic polyol (b3) types can also be used with satisfactory results in a single polyurethane formulation when one wants for instance to adjust blowing and gelling reactions by varying the ratio between gelling autocatalytic polyols (b2) and the blowing autocatalytic polyol (b3).

Acid neutralization of the polyol (b2) can also be considered when for instance delayed action is required. Acids used can be carboxylic acids such as formic, acetic, salicylic, oxalic or acrylic acids, an amino acid or a non-organic acid such as sulfuric or phosphoric acid.

Polyols pre-reacted with polyisocyanates and polyol (b2) with no free isocyanate functions can also be used in the polyurethane formulation. Isocyanate prepolymers based on polyol (b2) can be prepared with standard equipment, using conventional methods, such a heating the polyol (b2) in a reactor and adding slowly the isocyanate under stirring and then adding eventually a second polyol, or by prereacting a first polyol with a diisocyanate and then adding polyol (b2).

The isocyanates which may be used with the autocatalytic polyols of the present invention include aliphatic, cycloaliphatic, arylaliphatic and aromatic isocyanates. Aromatic isocyanates, especially aromatic polyisocyanates are preferred.

Examples of suitable aromatic isocyanates include the 4,4′-, 2,4′ and 2,2′-isomers of diphenylmethane diisocyante (MDI), blends thereof and polymeric and monomeric MDI blends toluene-2,4- and 2,6-diisocyanates (TDI), m- and p-phenylenediisocyanate, chlorophenylene-2,4-diisocyanate, diphenylene-4,4′-diisocyanate, 4,4′-diisocyanate-3,3′-dimehtyldiphenyl, 3-methyldiphenyl-methane-4,4′-diisocyanate and diphenyletherdiisocyanate and 2,4,6-triisocyanatotoluene and 2,4,4′-triisocyanatodiphenylether.

Mixtures of isocyanates may be used, such as the commercially available mixtures of 2,4- and 2,6-isomers of toluene diisocyantes. A crude polyisocyanate may also be used in the practice of this invention, such as crude toluene diisocyanate obtained by the phosgenation of a mixture of toluene diamine or the crude diphenylmethane diisocyanate obtained by the phosgenation of crude methylene diphenylamine. TDI/MDI blends may also be used. MDI or TDI based prepolymers can also be used, made either with polyol (b1), polyol (b2) or any other polyol as described heretofore. Isocyanate-terminated prepolymers are prepared by reacting an excess of polyisocyanate with polyols, including aminated polyols or imines/enamines thereof, or polyamines.

Examples of aliphatic polyisocyanates include ethylene diisocyanate, 1,6-hexamethylene diisocyanate, isophorone diisocyanate, cyclohexane 1,4-diisocyanate, 4,41′-dicyclohexylmethane diisocyanate, saturated analogues of the above mentioned aromatic isocyanates and mixtures thereof.

The preferred polyisocyantes for the production of rigid or semi-rigid foams are polymethylene polyphenylene isocyanates, the 2,2′, 2,4′ and 4,4′ isomers of diphenylmethylene diisocyanate and mixtures thereof. For the production of flexible foams, the preferred polyisocyanates are the toluene-2,4- and 2,6-diisocyanates or MDI or combinations of TDI/MDI or prepolymers made therefrom.

Isocyanate tipped prepolymer based on polyol (b2) can also be used in the polyurethane formulation. It is thought that using such an autocatalytic polyol in a polyol isocyanate reaction mixture will reduce/eliminate the presence of unreacted isocyanate monomers. This is especially of interest with volatile isocyanates such as TDI and/or aliphatic isocyanates in coating and adhesive applications since it improves handling conditions and workers safety.

For rigid foam, the organic polyisocyanates and the isocyanate reactive compounds are reacted in such amounts that the isocyanate index, defined as the number or equivalents of NCO groups divided by the total number of isocyanate reactive hydrogen atom equivalents multiplied by 100, ranges from 80 to less than 500 preferably from 90 to 100 in the case of polyurethane foams, and from 100 to 300 in the case of combination polyurethane-polyisocyanurate foams. For flexible foams, this isocyanate index is generally between 50 and 120 and preferably between 75 and 110.

For elastomers, coating and adhesives the isocyanate index is generally between 80 and 125, preferably between 100 to 110.

For producing a polyurethane-based foam, a blowing agent is generally required. In the production of flexible polyurethane foams, water is preferred as a blowing agent. The amount of water is preferably in the range of from 0.5 to 10 parts by weight, more preferably from 2 to 7 parts by weight based on 100 parts by weight of the polyol. Carboxylic acids or salts are also used as blowing agents and polyols such as (b2) are especially effective for this application.

In the production of rigid polyurethane foams, the blowing agent includes water, and mixtures of water with a hydrocarbon, or a fully or partially halogenated aliphatic hydrocarbon. The amount of water is preferably in the range of from 0.5 to 15 parts by weight, more preferably from 2 to 10 parts by weight based on 100 parts of the polyol. With excessive amount of water, the curing rate becomes lower, the blowing process range becomes narrower, the foam density becomes lower, or the moldability becomes worse. The amount of hydrocarbon, the hydrochlorofluorocarbon, or the hydrofluorocarbon to be combined with the water is suitably selected depending on the desired density of the foam, and is preferably not more than 40 parts by weight, more preferably not more than 30 parts by weight based on 100 parts by weight of the polyol. When water is present as an additional blowing agent, it is generally present in an amount from 0.5 to 10, preferably from 0.8 to 6 and more preferably from 1 to 4 and most preferably from 1 to 3 parts by total weight of the total polyol composition.

Hydrocarbon blowing agents are volatile C₁ to C₅ hydrocarbons. The use of hydrocarbons is known in the art as disclosed in EP 421 269 and EP 695 322, the disclosures of which are incorporated herein by reference. Preferred hydrocarbon blowing agents are butane and isomers thereof, pentane and isomers thereof (including cyclopentane), and combinations thereof.

Examples of fluorocarbons include methyl fluoride, perfluoromethane, ethyl fluoride, 1,1-difluoroethane, 1,1,1-trifluoroethane (HFC-143a), 1,1,1,2-tetrafluoroethane (HFC-134a), pentafluoroethane, difluoromethane, perfluoroethane, 2,2-difluoropropane, 1,1,1-trifluoropropane, perfluoropropane, dichloropropane, difluoropropane, perfluorobutane, perfluorocyclobutane.

Partially halogenated chlorocarbons and chlorofluorocarbons for use in this invention include methyl chloride, methylene chloride, ethyl chloride, 1,1,1-trichloroethane, 1,1-dichloro-1-fluoroethane (FCFC-141b), 1-chloro-1,1-difluoroethane (HCFC-142b), 1,1-dichloro-2,2,2-trifluoroethane (HCHC-123) and 1-chloro-1,2,2,2-tetrafluoroethane (HCFC-124).

Fully halogenated chlorofluorocarbons include trichloromonofluoromethane (CFC-11) dichlorodifluoromethane (CFC-12), trichlorotrifluoroethane (CFC-113), 1,1,1-trifluoroethane, pentafluoroethane, dichlorotetrafluoroethane (CFC-114), chloroheptafluoropropane, and dichlorohexafluoropropane. The halocarbon blowing agents may be used in conjunction with low-boiling hydrocarbons such as butane, pentane (including the isomers thereof), hexane, or cyclohexane or with water.

Use of carbon dioxide, either as a gas or as a liquid, as auxiliary blowing agent is especially of interest when water is present with the present technology. In addition to the foregoing critical components, it is often desirable to employ certain other ingredients in preparing polyurethane polymers. Among these additional ingredients are surfactants, preservatives, flame retardants, colorants, antioxidants, reinforcing agents, stabilizers and fillers.

In making polyurethane foam, it is generally preferred to employ an amount of a surfactant to stabilize the foaming reaction mixture until it cures. Such surfactants advantageously comprise a liquid or solid organosilicone surfactant. Other surfactants include polyethylene glycol ethers of long-chain alcohols, tertiary amine or alkanolamine salts of long-chain alkyl acid sulfate esters, alkyl sulfonic esters and alkyl arylsulfonic acids. Such surfactants are employed in amounts sufficient to stabilize the foaming reaction mixture against collapse and the formation of large, uneven cells. Typically, 0.2 to 3 parts of the surfactant per 100 parts by weight total polyol (b) are sufficient for this purpose.

One or more catalysts for the reaction of the polyol (and water, if present) with the polyisocyanate can be used. Any suitable urethane catalyst may be used, including tertiary amine compounds, amines with isocyanate reactive groups and organometallic compounds. Preferably the reaction is carried out in the absence of an amine or an organometallic catalyst or a reduced amount as described above. Exemplary tertiary amine compounds include triethylenediamine, N-methylmorpholine, N,N-dimethylcyclohexylamine, pentamethyldiethylenetriamine, tetramethylethylenediamine, bis (dimethylaminoethyl)ether, 1-methyl-4-dimethylaminoethyl-piperazine, 3-methoxy-N-dimethylpropylamine, N-ethylmorpholine, dimethylethanolamine, N-cocomorpholine, N,N-dimethyl-N′,N′-dimethyl isopropylpropylenediamine, N,N-diethyl-3-diethylamino-propylamine and dimethylbenzylamine. Exemplary organometallic catalysts include organomercury, organolead, organoferric and organotin catalysts, with organotin catalysts being preferred among these. Suitable tin catalysts include stannous chloride, tin salts of carboxylic acids such as dibutyltin di-laurate, as well as other organometallic compounds such as are disclosed in U.S. Pat. No. 2,846,408. A catalyst for the trimerization of polyisocyanates, resulting in a polyisocyanurate, such as an alkali metal alkoxide may also optionally be employed herein. The amount of amine catalysts can vary from 0.02 to 5 percent in the formulation or organometallic catalysts from 0.001 to 1 percent in the formulation can be used.

A crosslinking agent or a chain extender may be added, if necessary. The crosslinking agent or the chain extender includes low-molecular polyhydric alcohols such as ethylene glycol, diethylene glycol, 1,4-butanediol, and glycerin; low-molecular amine polyol such as diethanolamine and triethanolamine; polyamines such as ethylene diamine, xlylenediamine, and methylene-bis(o-chloroaniline). The use of such crosslinking agents or chain extenders is known in the art as disclosed in U.S. Pat. Nos. 4,863,979 and 4,963,399 and EP 549,120, the disclosure of which are incorporated herein by reference.

When preparing rigid foams for use in construction, a flame retardant is generally included as an additive. Any known liquid or solid flame retardant can be used with the autocatalytic polyols of the present invention. Generally such flame retardant agents are halogen-substituted phosphates and inorganic flame proofing agents. Common halogen-substituted phosphates are tricresyl phosphate, tris(1,3-dichloropropyl phosphate, tris(2,3-dibromopropyl) phosphate and tetrakis (2-chloroethyl) ethylene diphosphate. Inorganic flame retardants include red phosphorous, aluminum oxide hydrate, antimony trioxide, ammonium sulfate, expandable graphite, urea or melamine cyanurate or mixtures of at least two flame retardants. In general, when present, flame retardants are added at a level of from 5 to 50 parts by weight, preferable from 5 to 25 parts by weight of the flame retardant per 100 parts per weight of the total polyol present.

The applications for foams produced by the present invention are those known in the industry. For example rigid foams are used in the construction industry and for insulation for appliances and refrigerators. Flexible foams and elastomers find use in applications such as furniture, shoe soles, automobile seats, sun visors, steering wheels, armrests, door panels, noise insulation parts and dashboards.

Processing for producing polyurethane products are well known in the art. In general components of the polyurethane-forming reaction mixture may be mixed together in any convenient manner, for example by using any of the mixing equipment described in the prior art for the purpose such as described in Polyurethane Handbook, by G. Oertel, Hanser publisher.

The polyurethane products are either produced continuously or discontinuously, by injection, pouring, spraying, casting, calendering, etc; these are made under free rise or molded conditions, with or without release agents, in-mold coating, or any inserts or skin put in the mold. In case of flexible foams, those can be mono- or dual-hardness.

For producing rigid foams, the known one-shot prepolymer or semi-prepolymer techniques may be used together with conventional mixing methods including impingement mixing. The rigid foam may also be produced in the form of slabstock, moldings, cavity filling, sprayed foam, frothed foam or laminates with other material such as paper, metal, plastics or wood-board. Flexible foams are either free rise and molded while microcellular elastomers are usually molded.

The following examples are given to illustrate the invention and should not be interpreted as limiting in anyway. Unless stated otherwise, all parts and percentages are given by weight.

A description of the raw materials used in the examples is as follows.

DEOA LFG 85 percent is 85 percent diethanolamine in water.

Tegostab B8715 LF is a silicon-based surfactant available from Goldschmidt AG.

Dabco DC 5169 is a silicone-based surfactant available from Air Products and Chemicals Inc

Dabco 33 LV is a triethylenediamine based catalyst available from Air Products and Chemicals Inc.

Niax A-1 is a bis(2-dimethylaminoethyl)ether based catalyst available from Crompton Corporation.

Polycat 15 is a bis-(N,N-dimethyl-3-aminopropyl)amine based catalyst available from Air Products and chemicals Inc.

VORANOL CP 1421 is glycerine initiated polyoxypropylene polyoxyethylene polyol having an average hydroxyl number of 32 available from The Dow Chemical Company.

VORANOL CP 6001 is a glycerol initiated polyoxypropylene polyoxyethylene polyol having an average hydroxyl number of 28 available from The Dow Chemical Company.

SPECFLEX NC 632 is a 1,700 EW polyoxypropylene polyoxyethylene polol initiated with a blend of glycerol and Sorbitol available from the Dow Chemical Company

SPECFLEX NC-700 is a 40 percent SAN based copolymer polyol with an average hydroxyl number of 20 available from The Dow Chemical Company.

Specflex NE-150 is a MDI based isocyanate prepolymer available from The Dow Chemical Company.

VORANATE T-80 is TDI 80/20 available from The Dow Chemical Company.

Suprasec 2447 is a MDI isocyanate available from Huntsman corporation

Polyol A is a 1,000 equivalent weight propoxylated monol with 15 percent EO initiated with bis(N,N-dimethyl-3-aminopropyl)amine. Polyol A is a polyol with gelling catalytic activity.

Polyol B is a 1,000 EW propoxylated diol with 15 percent EO capping initiated with N-methyl-diethanolamine. Polyol B is polyol with blowing catalytic activity.

Polyol C is a 1,000 equivalent weight propoxylated diol initiated with N,N-dimethylaminopropylamine. Polyol C is polyol with blowing catalytic activity.

Polyol D is a 1,700 equivalent weight propoxylated tetrol initiated with 3,3′-diamino-N-methyl dipropylamine and capped with 15 percent EO. Polyol D is polyol with blowing catalytic activity.

All foams were made in the laboratory by preblending polyols, surfactants, crosslinkers, catalysts and water, then by adding the isocyanates under stirring at 3,000 RPM for 5 seconds. At the end of mixing the reactants are poured in a 30×30×10 cm aluminum mold heated at 60° C. which is subsequently closed. The release agent used is Klueber 41-2013 available from Klueber Chemie. Curing at a specific demolding times is assessed by manually demolding the part and running a indentation test, first cycle, at 50 percent deflection one minute after demold (crushing force) and by measuring the 50 percent IFD in Newton immediately after crushing (opening) all the cells of the part. Hot IFD is a measure of the degree of curing of the foam at demold. Foam density in kg/m³ is measured since it is a critical parameter.

### EXAMPLES 1, 2, 3 and 4

Molded flexible foams were made according to formulations 1, 2, 3 and 4 based on the gelling polyol, Polyol A. Comparative foam A was made with a blowing polyol, Polyol B. Comparative foam B was made with polyol C which is based on the polyols described in EP 539,819. The formulations and properties of the produced foams are given in Table I.

TABLE I

| | Example | | | | | |
|---|---|---|---|---|---|---|
| | 1 | 2 | 3 | 4 | A* | B* |
| Voranol | 40 | 60 | 65 | 65 | | |
| CP 6001 | | | | | | |
| Specflex | 50 | 30 | 30 | 30 | 50 | 50 |
| NC 632 | | | | | | |
| Voranol | 2 | 2 | 0 | 0 | 2 | 2 |
| CP 1421 | | | | | | |
| Polyol A | 10 | 5 | 5 | 5 | | |
| Polyol B | | | | | 50 | |
| Polyol C | | | | | | 50 |
| DEOA | 0.50 | 0.50 | 0.60 | 0.60 | 0.60 | 0.60 |
| LFG 85 | | | | | | |
| B-8715 | 0.50 | 0.50 | 0.50 | 0.50 | 0.50 | 0.50 |
| LF | | | | | | |
| Water | 3.7 | 3.7 | 3.7 | 3.7 | 3.7 | 3.7 |
| Specflex | | | 95 | 105 | | |
| NE 150 | | | | | | |
| (index) | | | | | | |
| Suprasec | 95 | 95 | | | 95 | 95 |
| 2447 | | | | | | |
| (index) | | | | | | |
| Mold exit | 29 | 36 | 52 | 52 | 37 | 26 |
| Time (s) | | | | | | |
| Demold | 210 | 240 | 240 | 240 | NA | 180 |
| Time (s) | | | | | | |
| Crushing | 540 | 380 | 535 | 310 | NA | 1,380 |
| Force (N) | | | | | | |
| Hot IFD | 335 | 330 | 275 | 260 | NA | 185 |
| (N) | | | | | | |
| Molded | 48.2 | 45.5 | 46.5 | 46.5 | NA | 45.3 |
| density | | | | | | |
| kg/m3 | | | | | | |
| Comment | | | | | Collapsed | |
| on final | | | | | | |
| foam | | | | | | |

*Not an example of the present invention.
The results show that Polyol A at low levels gives stable foam and can be used to replace conventional gelling catalysts. Use of just a polyol with blowing catalytic activity gives a collapsed foam. Polyol C does not as performing as well as polyol A as Polyol C requires a much higher use level.

### EXAMPLE 5-7

Formulations of Examples 5-7 show the production of a foam based on a combinations of polyols having gelling catalytic activity, Polyol A, and blowing catalytic activity (Polyol B). Comparative C, is based on only a polyol having blowing catalytic activity. The formulations and foam properties are given in Table II.

TABLE II

Example

| | 5 | 6 | | |
|---|---|---|---|---|
| | Molded | Molded | 7 | C* |
| VORANOL CP | 11.25 | 11.25 | 11.25 | 11.25 |
| 6001 | | | | |
| Specflex NC | 55 | 55 | 55.0 | 55.0 |
| 632 | | | | |
| Voranol CP | | | 2 | 2 |
| 1421 | | | | |
| Polyol A | 3.75 | 3.75 | 3.75 | |
| Polyol B | 30 | 30 | 30.0 | 33.75 |
| DEOA LFG85 | 0.60 | 0.60 | 0.6 | 0.6 |
| Water | 3.7 | 3.7 | 3.7 | 3.7 |
| Tegostab | 0.5 | 0.5 | 0.5 | 0.5 |
| B8715LF | | | | |
| Specflex | 95 | 105 | 95 | 95 |
| NE-150 | | | | |
| (index) | | | | |
| Mold exit | 34 | 34 | | |
| time (S) | | | | |
| Crushing | 535 | 370 | 230 | NA |
| force (N) | | | | |
| Hot IFD (N) | 290 | 280 | 210 | NA |
| Demold time | 240 | 240 | | |
| (s) | | | | |
| Density | 47 | 47 | 44.9 | NA |
| Kg/m3 | | | | |
| Comment on | | | | Collapsed |
| Foam | | | | |

*Comparative, not part of the invention.
Examples 5-7 confirm that good, stable foam is obtained with the combination of gelling Polyol A and blowing Polyol B. A foam produced with only a polyol with catalytic blowing activity collapsed (Comparative C).

### EXAMPLE 8

A comparison is carried out between a formulation with Polyol A, versus a conventional fugitive catalysts amine catalyst (comparative F and G), a (comparative E), a polyols with autocatalytic blowing activity (comparatives D and E). The formulations and foam properties are shown in Table III showing that comparative foam G was stabilized via addition of Dabco 33 LV while foam F with a lower level did collapse.

TABLE III

| | Example | | | | |
|---|---|---|---|---|---|
| | 8 | D* | E* | F* | G* |
| Voranol CP 6001 | 59 | 59 | 59 | 64 | 64 |
| Specflex NC 632 | 34 | 34 | 34 | 34 | 34 |
| Voranol CP 1421 | 2 | 2 | 2 | 2 | 2 |
| Polyol A | 5 | | | | |
| Polyol B | | 5 | | | |
| Polyol C | | | 5 | | |
| Niax A-1 | | | | 0.05 | 0.05 |
| Dabco 33LV | | | | 0.20 | 0.40 |
| Water | 3.7 | 3.7 | 3.7 | 3.7 | 3.7 |
| Tegostab B-8715LF | 0.5 | 0.5 | 0.5 | 0.5 | 0.5 |
| Specflex NE-150 | 100 | 100 | 100 | 100 | 100 |
| index | | | | | |
| Mold fill time (s) | 51 | NA | NA | NA | 46 |
| Demolding time | 4 | | | | 4 |
| (min) | | | | | |
| Foam aspect | OK | Collapsed | Collapsed | Collapsed | OK |
| Density | 45.5 | | | | 46.5 |
| Kg/m3 | | | | | |

*comparative examples.

Hot IFD of example 8 is 260 N while hot IFD of comparative foam G is 165 N, showing foam G catalyzed with triethylenediamine is less cured. These results confirm that Polyol A can replace conventional amine catalysts, including triethylenediamine, with good processing while Polyols B and C give unstable, incompletely cured foams.

### EXAMPLE 9 and 10

Foams were made with polyol A at two different levels to confirm its influence on foam curing. These foams were produced together with polyol D, a blowing polyol, based on the teaching of WO 01/58,976. Polycat 15, the amine used as initiator for Polyol A was also used for comparative purpose. The formulations and foam properties are given in Table IV.

TABLE IV

| | Example | | | | | |
|---|---|---|---|---|---|---|
| | 9 | 10 | H* | J* | K* | L* |
| Specflex | 34 | 18 | 34 | 34 | 64 | 34 |
| NC 632 | | | | | | |
| Specflex | 30.4 | 60.8 | 32 | 32 | 34 | 30.45 |
| NC 700 | | | | | | |
| Polyol A | 1.6 | 3.2 | | | | |
| Polyol D | 34 | 18 | 34 | 34 | | 34 |
| Niax A1 | | | | | 0.05 | |
| Dabco | | | 0.20 | 0.30 | 0.40 | |
| 33LV | | | | | | |
| Polycat 15 | | | | | | 0.25 |
| Dabco DC | 0.60 | 0.60 | 0.60 | 0.60 | 0.60 | 0.60 |
| 5169 | | | | | | |
| DEOA | 0.80 | 0.80 | 0.80 | 0.80 | 0.80 | 0.80 |
| LFG | | | | | | |
| Water | 3.5 | 3.5 | 3.5 | 3.5 | 3.5 | 3.5 |
| Voranate | | | | | | |
| T-80 | | | | | | |
| Index | 100 | 100 | 100 | 100 | 100 | 100 |
| Mold fill | 26 | 17 | NA | 23 | 23 | 27 |
| time (s) | | | | | | |
| Demold | 240 | 240 | NA | 240 | 240 | 240 |
| time (s) | | | | | | |
| Amine | No | No | strong | Strong | Strong | Strong |
| odor | | | | | | |
| Foam | OK | OK | Collapsed | OK | OK | DensiFied |
| aspect | | | | | | |
| Density | 32.2 | 35.8 | | 33.4 | 36 | 30.7 |
| Kg/m3 | | | | | | |
| Loss at | fair | small | | Fair | small | Large |
| vent holes | | | | | | |

*comparative examples

These results confirm that the gelation of the foaming reaction can be controlled by adjusting the level of polyol A. The use of Polycat 15 as indicated gave foam with a strong odor, confirming that all amines had not reacted with isocyanate at demold. The results also indicate the foaming mass was very fluid as shown by the large loss at vent holes and foam densification. Polyol D, a blowing polyol, when used by itself (comparatives H and J) had to be co-catalyzed with a relatively large amount of Dabco 33 LV to give a stable, cured foam.

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

What is claimed is

1. A process for the production of a polyurethane product by reaction of a mixture of
(a) at least one organic polyisocyanate with
(b) a polyol composition comprising
(b1) from 0 to 99 percent by weight of a polyol compound having a functionality of 2 to 8 and a hydroxyl number of from 20 to 800 and
(b2) from 100 to 1 percent by weight of at least one autocatalytic polyol with gelling characteristics, having a functionality of 1 to 8 and a hydroxyl number of from 15 to 800,
wherein the weight percent is based on the total amount of polyol component (b), and (b2) is obtained by alkoxylation of at least one initiator molecule of (b2a), (b2b), (b2c), (b2d), (b2e), (b2f) or (b2g) wherein
(b2a) is a compound of Formula I
R₂N—(CH₂)ₙ—NH—(CH2)ₙ—NR₂ (Formula I)
where n at each occurrence is independently an integer from 1 to 12,
and R at each occurrence is independently a C₁ to C₃ alkyl group;
(b2b) is a compound of Formula II 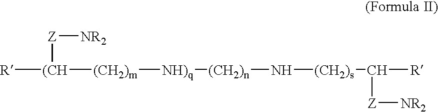
where R and n are as previously defined,
R′ at each occurrence is independently hydrogen, a linear or branched C₁ to C₁₂ alkyl, OH or NH₂,
m at each occurrence is independently an integer from 0 to 12,
q and s are independently integers from 0 to 12,
with the proviso that s is less than 3 when q is 0 and R′ is NH₂; and
Z at each occurrence is independently a direct bond or a linear or branched C₁ to C₁₂ alkyl;
(2bc) is a compound of Formula III
ₚ(E)-A[(CE₂)ₙ—N(E)—(CE₂)ₙ]ⱼ-A-(E)ₚ (Formula III)
where E at each occurrence is independently hydrogen, C₁-C₁₂ linear or branched alkyl, —RNR₂ or —ROH;
where n at each occurrence is independently an integer from 1 to 12;
R at each occurrence is independently a C₁ to C₃ alkyl group;
j is 1 to 6;
A is oxygen or nitrogen, and
p is 1 when A is oxygen and 2 when A is nitrogen,
with the provisos that n is at least 3 when each A is nitrogen and the molecule contains at least one NR2 group;
(b2d) is a compound of Formula IV 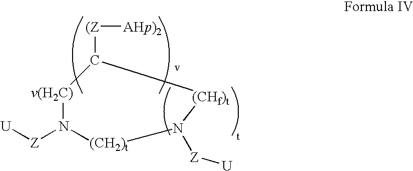
where Z, A, and p, are as previously defined,
v at each occurrence is independently an integer from 0 to 6,
t is an integer from 2 to 6, and
U at each occurrence is independently a C₁ to C₃ linear or branched alkyl, hydrogen, or NR₂ where R is as previously defined;
(b2e) is a compound w being selected from a cyclic or an aliphatic molecule containing an amidine group, a quinuclidine group, a triazaadamantane group, a N-methyl-piperazine group, an imidazole group, a pyridine group or a pyrrolidino group with one or more reactive hydrogens,
(b2f) is a compound which contains W with or without reactive hydrogens, as represented by in Formula V
W-((CH₂)ₘ-AHₚ)ᵥ (Formula V)
where W, A, m, v and p are previously defined, group with the proviso that when W is an imidazole group the hydroxyl number of (b2) is 48 or less and when W is a quinuclidine the hydroxyl number of (b2) is 200 or less;
(b2g) is a compound with contains a W groups as represented by Formula VI 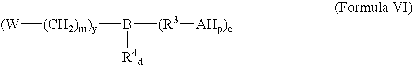
where W, A, m and p are as previously defined,
B is carbon, oxygen or nitrogen,
R⁴ is hydrogen or a C₁ to C₁₂ linear or branched alkyl,
R³ is C₁ to C₁₂ linear or branched alkyl,
e and y are 1 and d is zero when B is oxygen,
e and y are 1 and d is 2 when B is carbon,
when B is nitrogen, e, y and d are 1 or y is 2, d is zero and e is 1;
or (b2) is either (b2e), (b2f), or (b2g) complexed with a metal salt;
or (b2) is (b2h) a hydrodxyl-tipped prepolymer obtained from the reaction of an excess of (b2a), (b2b), (b2c), (b2d), (b2e) (b2f), or (b2g) with a polyisocyanate;
or (b2) is (b2i) a blend selected from (b2a), (b2b) (b2c), (b2d), (b2e), (b2f), (b2g), or (b2h);
(c) optionally in the presence of a blowing agent; and
(d) optionally additives or auxiliary agents known per se for the production of polyurethane foams, elastomers and/or coatings.

2. The process of claim 1 wherein (b2) contains at least one polyol based on an initiator molecule of (b2a) wherein n at each occurrence in Formula 1 is an integer of 2 to 4 and R is methyl.

3. The process of claim 2 wherein the initiator is bis-(N,N-dimethyl-3-amino propyl)-amine.

4. The process of claim 1 wherein (b2) contains at least one polyol based on an initiator molecule of (b2b) wherein R is methyl and R′ at each occurrence is methyl.

5. The process of claim 4 wherein the initiator is N,N-dimethyl-N ′-ethylenediamine.

6. The process of claim 1 wherein (b2) contains at least one polyol based on an initiator molecule of (b2c) wherein j is an integer from 1 to 3.

7. The process of claim 6 wherein A at each occurrence is nitrogen.

8. The process of claim 6 wherein the initiator is N,N,2,2-tetramethyl-1,3-propanediamine.

9. The process of claim 1 wherein (b2) contains at least one polyol based on an initiator molecule of (b2d).

10. The process of claim 9 wherein the initiator molecule is cyclen or 5-amino-1,3,-diisopropyl-5-hydroxymethylhexahydropyrimidine.

11. The process of claim 1 wherein (b2) contains at least one polyol based on an initiator molecule of (b2e).

12. The process of claim 11 wherein the initiator contains at least one initiator selected from imidazole, 2,2-bis-(4,5-dimethylimidazole), 2-ethyl 4-methyl imidazole, 2-phenyl imidazole, 1,5,7-triazabicyclo (4,4.0) dec-5-ene, dicyandiamide, 1,1,3,3-tetramethyl guanidine, 2-amino-pyrimidine or 3-pyrrolidinol.

13. The process of claim 1 wherein (b2) contains at least one polyol based on an initiator molecule of (b2f).

14. The process of claim 13 wherein v is 1 or 2.

15. The process of claim 13 wherein the polyol contains at least initiator selected from 1-amino-4-methyl-piperazine; 2,4-diamino-6-hydroxypyrimidine; 2-aminopyrimidine; 1-(3-aminopropyl)-imidazole; 3-quinuclidinol; 3-hydroxymethyl quinuclidine; or 7-amino-1,3,5-triazaadamantane.

16. The process of claim 1 wherein (b2) contains at least one polyol based on an initiator molecule of (b2g).

17. The process of claim 16 wherein the initiator is 1-methy-4-[N-methyl-N-(2-amino-2-methylpropyl)amino]piperidine, or 7-(N-(2-nitroisobutylamino))-1,3,5-triazaadamantane.

18. The process of claim 1 wherein the polyurethane product is a rigid foam and polyols (b1) and (b2) have an average functionality of 3 to 6 and an average hydroxyl number of 200 to 800.

19. The process of claim 1 wherein the polyurethane product is a flexible foam and polyols (b1) and (b2) have an average functionality of 2 to 4 and an average hydroxyl number of 20 to 100.

20. The process of claim 1 wherein the polyurethane product is an elastomer, a coating or adhesive.

21. A polyol produced by alkoxylation of any one of the initiators of (b2a) to (b2g) as defined in (b2) claim 1.

22. A hydroxyl-tipped prepolymer obtained from the reaction of an excess of any one of (b2a)-((b2g) with a polyisocyanate.
